(19) United States
(12) Patent Application Publication
(10) Pub. No.: US 2014/0147232 A1
(43) Pub. Date: May 29, 2014

(54) BALE HANDLING

(71) Applicants: Paul James Anderson, Wyndham (NZ); Michelle Stephanie Anderson, Wyndham (NZ)

(72) Inventors: Paul James Anderson, Wyndham (NZ); Michelle Stephanie Anderson, Wyndham (NZ)

(21) Appl. No.: 13/820,163

(22) PCT Filed: Aug. 25, 2011
(86) PCT No.: PCT/NZ2011/000168

§ 371 Date: May 9, 2013

(30) Foreign Application Priority Data
Sep. 1, 2010 (NZ) 587725

(51) Int. Cl. A01D 87/12

(52) U.S. Cl. CPC A01D 87/127
USPC 414/24.5; 414/800

(57) ABSTRACT

A bale grab device is provided which includes: at least one frame member; a central projecting member; and at least two holding arms, wherein the holding arms are located on either side of the central projecting member and wherein each holding arm is configured to be capable of being independently moved between an open and a closed position wherein a separate gripping region is provided between each of the holding arms and the central projecting member.

### TECHNICAL FIELD

The present invention relates to improvements in and relating to bale handling. In particular, the present invention relates to bale handling apparatus for lifting and transporting bales.

### BACKGROUND ART

Apparatus for lifting and transporting hay bales are well known in the art. Typically two different types of handling equipment are used for transporting bales, the first is used for lifting bales and locating them on the second type of handling equipment, namely the transporting apparatus.

This method becomes particularly inefficient if a small number of bales are required to be transported a short distance. The only other option being to transport the bales using only the first lifting apparatus. The disadvantage of this approach is often the lifting apparatus is not designed for transportation of the bales over any significant distance. The known prior art lifting apparatus are typically only designed to lift and place one bale at a time. This is a disadvantage if a number of bales need to be moved from the field they were produced to another location. This inefficiency is exacerbated when the bales are produced at irregular intervals by a baling machine and therefore require independent pick up at relatively distant locations. This makes transportation of a small number of bales over a moderate distance inefficient.

It would therefore be advantageous to have a bale handling apparatus that was capable of independently lifting, transporting and placing more than one bale over at least a moderate distance.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

It is an object of the present invention to address the foregoing problems or at least to provide the public with a useful choice.

Further aspects and advantages of the present invention will become apparent from the ensuing description which is given by way of example only.

### DISCLOSURE OF THE INVENTION

According to one aspect of the present invention there is provided a bale grab apparatus which includes:

at least one frame member;

a central projecting member; and

at least two holding arms,

characterised in that the holding arms are located on either side of the central projecting member and configured to be capable of being moved between an open and a closed position wherein a gripping region is provided between each of the holding arms and the said central projecting member.

In preferred embodiments, in use, a bale may be retained between the said central projecting member and one substantially closed holding arm.

In preferred embodiments movement of each of the holding arms may be made independently with respect to the other holding arm.

In the context of the present invention, as would be understood by a person skilled in the art, a bale grab device recited as being in an open position refers to a position, whereby the bale grab can be freely positioned over, or about a bale. In this position, the bale lies between one holding arm and either the central projecting member or frame member (the gripping region). Activation of the holding arm into a closed position results in the bale being gripped in the gripping region between the holding arm and the central projecting member and/or frame. A closed position also refers to the position, whereby the holding arm is actuated, so as to move into the gripping position with no bale present. This moves the holding arm into a more compact position for storage or transport.

In preferred embodiments the at least one frame member provides a support frame onto which the functional elements of the bale grab device are attached.

It will be understood to a person skilled in the art that functional elements refer to any device or fitting or group thereof which is/are configured to perform a specific function. The term ‘functional elements’ does not include devices or fittings which serve only in altering the aesthetics of the bale grab device.

Functional elements that could be attached to the support frame may include, but should not be limited to:

one or more pivot attachment points;

one or more actuator attachment points;

one or more couplings for connecting the frame to a tractor or other similar vehicle;

one or more support members.

In preferred embodiments the at least one frame member may be constructed from a plurality of frame elements.

In some preferred embodiments the at least one frame member may be constructed from a single element such as a cast.

In some preferred embodiments the at least one frame member may be formed as a partial curve, or formed to approximate a partial curve. In some embodiments the frame member may be angled to create a curve. It will be apparent to a person skilled in the art that for grippingly engaging with round bales it would be advantageous that the frame member have a curved profile corresponding to the diameter of a standard round bale, thus maximising the surface contact between the bale grab device and the bale. Conversely for the purposes of grippingly engaging with a square bale it would be advantageous that the frame member have at least a portion of which is substantially flat. In preferred embodiments the partial curve or approximation of a partial curve includes portions which facilitate gripping engagement with both round and square type bales.

In preferred embodiments the central projecting member may be configured to project orthogonally from the front face of the frame member.

In preferred embodiments the central projecting member may be substantially centrally disposed between the said at least two holding arms.

In preferred embodiments the central projecting member may be substantially equivalent in height to the holding arms.

In preferred embodiments the central projecting member may be substantially U-shaped.

In preferred embodiments the central projecting member may be of tubular construction.

In preferred embodiments the central projecting member may be in an opposed relationship to the holding arms, thereby providing an opposing member against which a bale may bear when gripped by a holding arm, the area between the said central projecting member and a holding arm defining a gripping region.

In preferred embodiments the holding arms may be pivotably attached to the frame member. In use, gripping of a bale may be achieved by pivoting of the respective holding arm towards the support frame or part thereof, gripping the said bale therebetween.

In other preferred embodiments the holding arms may be slidably attached to the frame member. In use gripping of a bale being achieved by sliding of the respective holding arm towards the support frame or part thereof, gripping the said bale therebetween.

In preferred embodiments the holding arms may be pivotably attached to the frame member by way of one or more pivots.

In preferred embodiments the holding arms may be pivotably attached to the frame member by way of upper and lower hinge plates.

In preferred embodiments the upper and lower hinge plates include coaxially aligned apertures therethrough.

In other preferred embodiments the holding arms may be pivotably attached to the frame member by way of a pivot shaft attached directly or indirectly to the frame member. It will be apparent to a person skilled in the art that there is any number of ways that the holding arms of the present invention may be pivotably attached to a frame, therefore the exact configuration of the pivotal arrangement should not be seen as being limiting.

In preferred embodiments each holding arm may include:

a holding portion;

an attachment portion; and

an actuator attachment portion.

In preferred embodiments the holding portion may be a widened portion of the holding arm.

In preferred embodiments the holding portion may simply be the region between the attachment portion and the distal end of the holding arm.

In preferred embodiments the holding portion may include a plurality of fingers or projections oriented orthogonally to the holding arm and in a vertical orientation. In use, the plurality of fingers or projections increase the surface area of the holding portion in contact with a bale, thereby helping to retain the bale in place.

In some preferred embodiments the holding portion may be a further structure that is welded or otherwise attached to the arm portion.

In preferred embodiments the holding portion may be a rectangular shaped tubular framework.

In preferred embodiments the holding portion may be formed in a partially curved shape, or approximate a partially curved shape in a vertical plane so as to conform to the shape of a standard round hay bale.

In preferred embodiments the holding portion may include rounded corners and an avoidance of sharp projections so as to avoid puncturing or damage to hay bale bags or other such coverings on hay bales that are to be handled by the apparatus.

In preferred embodiments the attachment portion may be a hinge bushing.

In preferred embodiments the hinge bushing may be located between the holding portion and the actuator attachment end of the holding arm.

Location of the hinge bushing at the opposite end of the holding arm to the holding portion, with the actuator attachment located therebetween, is a further embodiment that has been considered and therefore should not be seen as falling outside the scope of the present invention.

In preferred embodiments the actuator attachment portion may be a clevis or similar U-shaped portion on the actuator attachment end of the arm portion.

In preferred embodiments the pivot axes of the attachment portion and actuator attachment portion are parallel, or at least substantially so.

In preferred embodiments each holding arm may be attached to the frame member by way of a pivot shaft inserted through each of the coaxially aligned apertures in the upper and lower pivot plates and the hinge bushing of the holding arm, thereby allowing a single pivotable axis about which the holding arm may rotate.

In preferred embodiments rotation of the holding arm may be facilitated by way of an actuator disposed between an attachment on the frame member and the actuator attachment portion.

In preferred embodiments the actuator may be in the form of a hydraulic cylinder. However, it will be apparent to a person skilled in the art that a number of alternative actuator means exist that could facilitate the required pivoting motion, a non limiting list being, linear actuators, pneumatic cylinders, a motor driving gears or chains.

In preferred embodiments the frame member may have one or more fittings attached to it in the form of a loader arm quick connect attachment, such as, but not limited to:

a 3 point hitch attachment.

As will be appreciated by a person skilled in the art, a large number of quick coupling technologies exist and are yet to be created, therefore the exact configuration of the attachment should not be seen as being limiting.

According to a further aspect of the present invention there is provided a method of handling one or two hay bales concurrently, the method including the steps of:
a) locating a first hay bale to be handled between a first holding arm holding portion and a central projecting member; and
b) activating said first holding arm holding portion to move into a gripping position; and
c) locating a second hay bale to be handled between a second holding arm holding portion and a central projecting member; and
d) activating said second holding arm holding portion to move into a gripping position.

### BRIEF DESCRIPTION OF DRAWINGS

Further aspects of the present invention will become apparent from the following description which is given by way of example only and with reference to the accompanying drawings in which:

FIG. 1 is an front isometric view of a bale grab device in accordance with one preferred embodiment of the present invention, and

FIG. 2 is an rear isometric view of the bale grab device of FIG. 1.

### BEST MODES FOR CARRYING OUT THE INVENTION

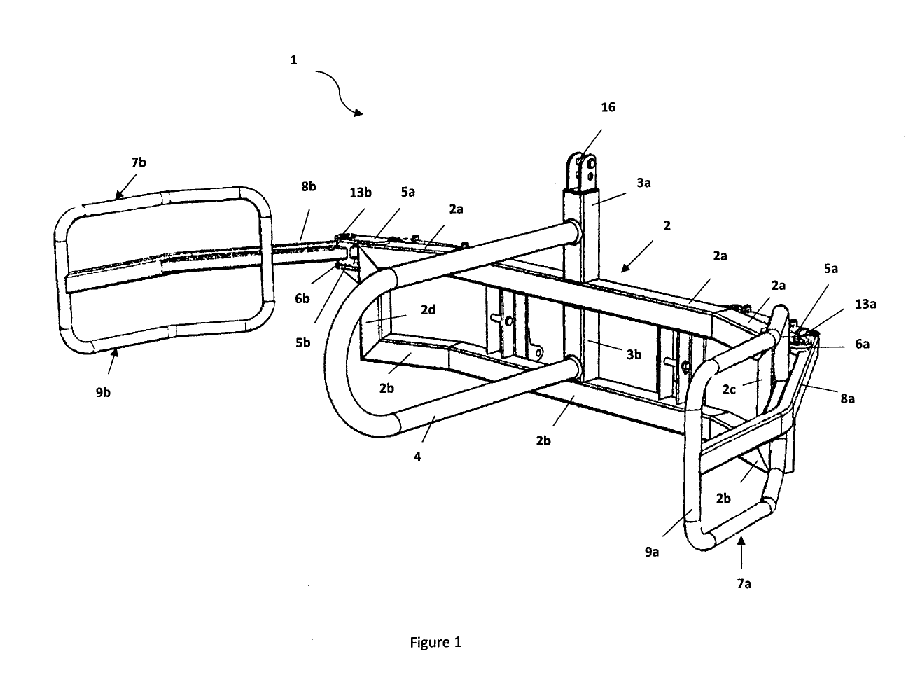

With respect to FIG. 1, there is shown a bale grab device in an open configuration, as generally indicated by arrow 1.

The bale grab device 1 has frame member 2 which comprises upper members 2a, lower frame members 2b, left frame member 2c and right frame member 2d, together which form an approximate partially curved frame member of the bale grab device. The curvature attained generally corresponds to the diameter of a standard round bale (not shown), although both larger and smaller bales can be gripped. The flat front face 17 provides a further region onto which a square bale (not shown) can be gripped. Attached to frame member 2 by brace member 3a, and tilt arm 3b is a central projecting member in the form of a U-shaped tube 4. The central projecting member 3b is attached orthogonally to the centre of the front face 17 of frame member 2. Welded to the upper ends of left 2c and right 2d frame members are upper 5a and lower 5b hinge plates. Left grab arm 7a pivot bushing 6a and right grab arm 7b pivot bushing 6b pivotably engage with respective left and right pivot shafts 13a, 13b between upper 5a and lower 5b hinge plates.

Left 7a and right 7b grab arms include arms 8a, 8b, grab arm holding portions 9a, 9b actuator 11a, 11b grab arm attachment portions 10a, 10b. Disposed between the grab arm holding portions 9a, 9b and actuator 11a, 11b grab arm attachment portions 10a, 10b are grab arm pivots 6a, 6b.

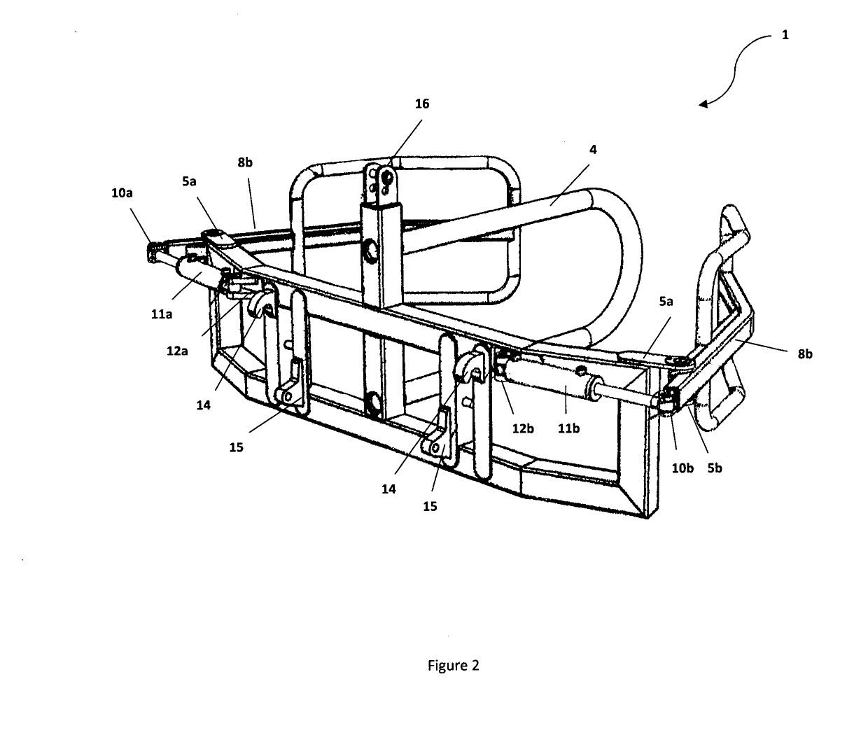

Welded to the rear of frame member 2 are actuator 11a, 11b frame attachment portions 12a, 12b. Left actuator 11a is attached between left actuator 11a frame attachment portion 12a and left grab arm attachment portion 10a. Left grab arm 7a is moved between an open position, shown in FIG. 1, and a substantially closed position, shown in FIG. 2, by extension and retraction of an actuator in the form of independently operable hydraulic cylinder 11a.

Right actuator 11b is attached between right actuator 11b frame attachment portion 12b and right grab arm attachment portion 10b. Right grab arm 7b is moved between an open position, shown in FIG. 1, and a substantially closed position, shown in FIG. 2, by extension and retraction of an actuator in the form of independently operable hydraulic cylinder 11b.

Also welded to the rear of frame member 2 are loader arm (not shown) quick connect fittings in the form of upper hook couplings 14 and lower locking members 15. As will be appreciated by a person skilled in the art, the quick coupling system shown may vary depending on the type of loader arm coupling that is used. The lower locking members 15 also operate with upper attachment member 16 to facilitate attachment to a standard 3 point hitch attachment (also not shown).

Aspects of the present invention have been described by way of example only and it should be appreciated that modifications and additions may be made thereto without departing from the scope thereof.

1. A bale grab device, comprising:
at least one frame member;
a central projecting member;
at least two holding arms;
the holding arms are located on either side of the central projecting member and wherein each holding arm is configured to be capable of being independently moved between an open and a closed position wherein a separate gripping region is provided between each of the holding arms and the said central projecting member.

2. A bale grab device in accordance with claim 1, wherein a bale is retained between the said central projecting member and one substantially closed holding arm.

3. A bale grab device in accordance with claim 1, wherein movement of each of the holding arms can be made independently with respect to the other holding arm.

4. A bale grab device in accordance with claim 1, wherein the at least one frame member provides a support frame onto which functional elements of the bale grab device are attached.

5. A bale grab device in accordance with claim 1, wherein the at least one frame member is constructed from a plurality of frame elements.

6. A bale grab device in accordance with claim 1, wherein the at least one frame member is formed in a partially curved shape.

7. A bale grab device as claimed in claim 6 wherein the partially curved shape of the frame member corresponds with the diameter of a standard sized round hay bale.

8. A bale grab device as claimed in claim 6 wherein the partially curved frame member includes at least one flat region with which a square bale, or part thereof, can be grippingly engaged.

9. A bale grab device in accordance with claim 1, wherein the central projecting member projects orthogonally from the front face of the frame member.

10. A bale grab device in accordance with claim 1, wherein the central projecting member is substantially centrally disposed between the said at least two holding arms.

11. A bale grab device in accordance with claim 9, wherein the central projecting member is substantially equivalent in height to the height of the holding arms.

12. A bale grab device in accordance with claim 9, wherein the central projecting member is in an opposing relationship to the holding arms.

13. A bale grab device in accordance with claim 1, wherein the holding arms are pivotably attached to the frame member.

14. A bale grab device in accordance with claim 13, wherein the holding arms are pivotably attached to the frame member by way of upper and lower hinge plates.

15. A bale grab device in accordance with claim 14, wherein the upper and lower hinge plates include coaxially aligned apertures therethrough.

16. A bale grab device in accordance with claim 1, wherein each holding arm includes:
a holding portion;
an attachment portion; and
an actuator attachment portion.

17. A bale grab device in accordance with claim 16, wherein the holding portion is a rectangular shaped tubular framework.

18. A bale grab device in accordance with claim 16, wherein the holding portion is curved in a vertical plane so as to conform to the shape of a standard round hay bale.

19. A bale grab device in accordance with claim 16, wherein the holding portion includes rounded corners and an avoidance of sharp projections so as to avoid puncturing or damaging hay bale bags or other such coverings on hay bales that are to be handled by the apparatus.

20. A bale grab device in accordance with claim 16, wherein the attachment portion is a hinge bushing.

21. A bale grab device in accordance with claim 20, wherein the hinge bushing is located between the holding portion and the actuator attachment end of the holding arm.

22. A bale grab device in accordance with claim 16, wherein the actuator attachment portion is a clevis or similar U-shaped portion on the actuator attachment end of the arm portion.

23. A bale grab device in accordance with claim 16, wherein the attachment portion and actuator attachment portion include pivot axes which are parallel, or at least substantially so.

24. A bale grab device in accordance with claim 16, wherein rotation of the holding arm is facilitated by way of an actuator disposed between an attachment on the frame member and the actuator attachment portion.

25. A bale grab device in accordance with claim 1, wherein the frame member includes one or more fittings for attaching the frame member to a loading device attached to it in the form of a loader arm quick connect attachment.

26. A method of handling one or two hay bales concurrently, the method comprising the steps of:
a) locating a first hay bale to be handled in a first gripping region defined by a first holding arm holding portion and a central projecting member; and
b) activating said first holding arm holding portion to move into a gripping position; and
c) locating a second hay bale to be handled in a second gripping region defined by a second holding arm holding portion and a central projecting member; and
d) activating said second holding arm holding portion to move into a gripping position.

27. (canceled)

28. (canceled)
